(19) United States
(12) Patent Application Publication
(10) Pub. No.: US 2026/0162859 A1
(43) Pub. Date: Jun. 11, 2026

(54) BONDED MAGNET, ON-VEHICLE MAIN MOTOR AND OIL PUMP COMPRISING BONDED MAGNET, CURABLE COMPOSITION FOR BONDED MAGNET, AND METHOD FOR PRODUCING BONDED MAGNET

(71) Applicant: NICHIA CORPORATION, Anan-shi (JP)

(72) Inventors: Shingo AZUMA, Tokushima-shi (JP); Hirofumi ICHIKAWA, Tokushima-shi (JP); Masafumi KURAMOTO, Tokushima-shi (JP); Takahiro HONGO, Anan-shi (JP); Shuichi TADA, Komatsushima-shi (JP)

(73) Assignee: NICHIA CORPORATION, Anan-shi (JP)

(21) Appl. No.: 19/412,749

(22) Filed: Dec. 8, 2025

(30) Foreign Application Priority Data
Dec. 9, 2024 (JP) 2024-214285
Jul. 3, 2025 (JP) 2025-113062

(51) Int. Cl. H01F 1/053; H01F 7/02; H01F 41/02

(52) U.S. Cl. CPC H01F 1/0533; H01F 7/02; H01F 41/0266; H01F 41/0293

(57) ABSTRACT

A bonded magnet for use in applications in which the bonded magnet is immersed in or in contact with an oil, the bonded magnet including a cured product of a curable composition comprising: a magnetic powder; at least one epoxy resin that is at least one of a phenol novolac-type epoxy resin, a cresol novolac-type epoxy resin, or a triphenylmethane-type epoxy resin; and at least one phenolic resin-based curing agent that is at least one of a novolac-type phenolic resin, a cresol novolac-type phenolic resin, or a triphenylmethane-type phenolic resin.

### CROSS-REFERENCE TO RELATED APPLICATIONS

This application claims priority to Japanese Patent Application No. 2024-214285, filed on Dec. 9, 2024, and Japanese Patent Application No. 2025-113062, filed on Jul. 3, 2025. The disclosures of these applications are hereby incorporated by reference in their entireties.

### BACKGROUND

### Technical Field

One aspect of the present disclosure relates to a bonded magnet, and to an on-vehicle main motor and oil pump that comprise the bonded magnet. Another aspect of the present disclosure relates to a curable composition for the bonded magnet and a method for producing the bonded magnet.

### Background Art

In the related art, bonded magnets in which a magnetic powder such as a ferrite powder or a rare earth magnetic powder such as a Sm—Co-based magnetic powder, a Nd—Fe—B-based magnetic powder, or a Sm—Fe—N-based magnetic powder is bonded by a binder resin have been examined for use in various applications.

Bonded magnets have good magnetic properties and may also be required to have good heat resistance, depending on the application. In applications requiring heat resistance, use of a thermosetting resin, such as an epoxy resin for example, as a binder resin for a bonded magnet has been examined.

For example, Japanese Patent Publication No. 2022-17908 describes, as a bonded magnet compound that can be used to obtain a bonded magnet molded body with good crushing strength at both room temperature and high temperatures, a bonded magnet compound that contains a magnetic powder and a resin composition containing an epoxy resin, a curing agent such as a phenolic resin curing agent, and a coupling agent having a functional group that can react with a glycidyl group, in which the epoxy resin and the curing agent are contained such that the amount of hydroxyl groups per 1 g of the cured product [=curing agent content [g]×1000/(hydroxyl equivalent of the curing agent×(epoxy resin content [g]+curing agent content [g]))] is 3. 0 mmol/g or more. Japanese Patent Publication No. 2022-17908 also describes a bonded magnet produced by compression-molding this bonded magnet compound.

### SUMMARY

In recent years, the use of bonded magnets in applications in which the bonded magnet is immersed in or in contact with oil, such as in an on-vehicle main motor or an oil pump, and in some cases, in applications in which the bonded magnet is immersed in or in contact with oil at a relatively high temperature has been examined. Therefore, there has been a demand for a bonded magnet that has not only good heat resistance but also good oil resistance.

In addition, in applications such as in on-vehicle main motors and oil pumps, a bonded magnet having a relatively complex shape may be required. A bonded magnet may be required to have a complex shape not only in applications involving immersion in or contact with oil, but in other applications as well.

When an epoxy resin, which is a thermosetting resin, is used as a binder resin, a bonded magnet has conventionally been produced by a compression molding method in the related art, as in producing of the bonded magnet described in Japanese Patent Publication No. 2022-17908. However, in compression molding, the amount of binder resin that is used is generally small (usually 5 mass % or less), and thus it is difficult to produce a magnet having a complex shape.

Examples of methods that may be used to produce a bonded magnet having a relatively complex shape include injection molding and transfer molding. Large molding machines with built-in magnetic field coils are commercially available, and therefore among these methods, the injection molding method may be easily applied to the production of a relatively large bonded magnet molded article that is suitable for use in a motor or the like. In addition, the injection molding method may allow a higher production speed than the transfer molding method, and thus tends to be suitable for mass production. However, in terms of continuous moldability, it is usually difficult to use the injection molding method to produce a bonded magnet using a thermosetting resin such as an epoxy resin as the binder resin. On the other hand, with the transfer molding method, an epoxy resin may be used as the binder resin, but even with the transfer molding method, it may be difficult to control the curing reaction, and there are concerns that the pot life might worsen and fluidity in the mold might decrease; therefore, it may be difficult to successfully produce a bonded magnet in some cases.

Thus, an object of an embodiment of the present disclosure is to provide a bonded magnet having good heat resistance and oil resistance and may be suitably used in applications in which the bonded magnet is immersed in or in contact with an oil, such as in an on-vehicle main motor or an oil pump.

Another object of an embodiment of the present disclosure is to provide an on-vehicle main motor having good performance. Yet another object of an embodiment of the present disclosure is to provide an oil pump having good performance.

Moreover, an object of another embodiment of the present disclosure is to provide a curable composition for a bonded magnet, which allows for obtaining a bonded magnet having good heat resistance and oil resistance and having a high degree of freedom in shape, or to provide a curable composition for a bonded magnet, which allows for obtaining a bonded magnet having good heat resistance and oil resistance, the curable composition being applicable to an injection molding method or a transfer molding method.

Furthermore, one object of another embodiment according to the present disclosure is to provide a method for producing a bonded magnet, which allows for successfully producing a bonded magnet having good heat resistance and oil resistance and having a high degree of freedom in shape.

A bonded magnet according to an embodiment of the present disclosure comprises a cured product of a curable composition comprising: a magnetic powder; at least one epoxy resin that is at least one of a phenol novolac-type epoxy resin, a cresol novolac-type epoxy resin, or a triphenylmethane-type epoxy resin; and at least one phenolic resin-based curing agent that is at least one of a novolac-type phenolic resin, a cresol novolac-type phenolic resin, or a triphenylmethane-type phenolic resin, and the bonded magnet is used in applications in which the bonded magnet is immersed in or in contact with an oil. In a bonded magnet according to another embodiment of the present disclosure, the curable composition further comprises a phosphate ester.

An on-vehicle main motor according to an embodiment of the present disclosure comprises the bonded magnet described above. Moreover, an oil pump according to an embodiment of the present disclosure comprises the bonded magnet described above.

A curable composition for a bonded magnet according to another embodiment of the present disclosure comprises: a magnetic powder; at least one epoxy resin that is at least one of a phenol novolac-type epoxy resin, a cresol novolac-type epoxy resin, or a triphenylmethane-type epoxy resin; at least one phenolic resin-based curing agent that is at least one of a novolac-type phenolic resin, a cresol novolac-type phenolic resin, or a triphenylmethane-type phenolic resin; and a phosphate ester.

A method for producing a bonded magnet according to another embodiment of the present disclosure comprises a step of injection molding or transfer molding the curable composition for a bonded magnet described above, and subsequently curing the molded curable composition.

According to an embodiment of the present disclosure, a bonded magnet that has good heat resistance and oil resistance and may be suitably used in applications in which the bonded magnet is immersed in or in contact with an oil, such as in an on-vehicle main motor or an oil pump, may be provided.

Furthermore, according to an embodiment of the present disclosure, an on-vehicle main motor having good performance may be provided. Moreover, according to an embodiment of the present disclosure, an oil pump having good performance may be provided.

According to another embodiment of the present disclosure, a curable composition for a bonded magnet may be provided, which allows for obtaining a bonded magnet having good heat resistance and oil resistance and having a high degree of freedom in shape, or a curable composition for a bonded magnet may be provided, which allows for obtaining a bonded magnet having good heat resistance and oil resistance and being applicable to an injection molding method or a transfer molding method.

Furthermore, according to another embodiment of the present disclosure, a method for producing a bonded magnet may be provided, which allows for successfully obtaining a bonded magnet having good heat resistance and oil resistance and having a high degree of freedom in shape.

### BRIEF DESCRIPTION OF DRAWINGS

FIG. 1 is a graph of the loss tangents (tan δ) of flexural strength test pieces (cured products of curable compositions for bonded magnets) of Example 1 and Comparative Example 1.

### DETAILED DESCRIPTION

Embodiments of the present disclosure will be described below. The embodiments described below are examples for embodying the technical idea of the present disclosure, and are not intended to limit the present disclosure to the described embodiments. Also, a numerical range described as “a range of X to Y” in the present specification indicates a range that includes the numerical value of X as the minimum value and the numerical value of Y as the maximum value.

### Curable Composition for Bonded Magnet

A curable composition for a bonded magnet according to one aspect of the present embodiment comprises: a magnetic powder; at least one epoxy resin that is at least one of a phenol novolac-type epoxy resin, a cresol novolac-type epoxy resin, or a triphenylmethane-type epoxy resin; at least one phenolic resin-based curing agent that is at least one of a novolac-type phenolic resin, a cresol novolac-type phenolic resin, or a triphenylmethane-type phenolic resin; and a phosphate ester. The phenol novolac-type epoxy resin, the cresol novolac-type epoxy resin, or the triphenylmethane-type epoxy resin preferably has an epoxy equivalent that is 250 g/eq or less. The novolac-type phenolic resin, the cresol novolac-type phenolic resin, or the triphenylmethane-type phenolic resin preferably has a hydroxyl equivalent that is 150 g/eq or less.

A bonded magnet having good heat resistance and oil resistance may be obtained by using, as an epoxy resin which is a main agent, at least one of a phenol novolac-type epoxy resin, a cresol novolac-type epoxy resin, or a triphenylmethane-type epoxy resin, preferably having an epoxy equivalent that is 250 g/eq or less, and using, as a curing agent, at least one of a novolac-type phenolic resin, a cresol novolac-type phenolic resins, or a triphenylmethane-type phenolic resin, preferably having a hydroxyl equivalent that is 150 g/eq or less. Epoxy resins generally have good heat resistance, but this combination of the epoxy resin (main agent) and the curing agent may realize not only good heat resistance, but also particularly good oil resistance. Moreover, the curable composition for a bonded magnet, the composition thereof comprising a combination of the epoxy resin (main agent) and the curing agent, exhibits good moldability as compared with other curable compositions.

Furthermore, the curable composition for a bonded magnet of the present embodiment exhibits even better moldability when comprising a phosphate ester in addition to the combination of the epoxy resin (main agent) and the curing agent described above. When the curable composition for a bonded magnet comprises a phosphate ester in addition to the combination of the epoxy resin (main agent) and the curing agent described above, the curable composition is applicable to injection molding and transfer molding, and a bonded magnet having a relatively complex shape may be easily obtained. Further, by adding the phosphate ester, a high degree of filling with the magnetic powder may be achieved, or the orientation of the magnetic powder may be improved, and the residual magnetic flux density (Br) may be improved.

Accordingly, the curable composition for a bonded magnet of the present embodiment is applicable to an injection molding method or a transfer molding method, may be used to obtain a bonded magnet that has good heat resistance and oil resistance, and may be used to obtain a bonded magnet that has good heat resistance and oil resistance while having a high degree of freedom in shape. As used herein, the phrase “high degree of freedom in shape” means that bonded magnets of various shapes ranging from a simple shape to a relatively complex shape may be easily produced. The addition of a phosphate ester tends to improve moldability, particularly moldability in injection molding and transfer molding, not only in the case of the combination of the epoxy resin (main agent) and the curing agent comprised in the curable composition for a bonded magnet according to the present embodiment, but also in the case of epoxy resins in general. However, the effect is remarkable in the case of a polyfunctional epoxy resin, and is even more remarkable in the case of the above-described combination of the epoxy resin (main agent) and curing agent.

The content of the magnetic powder in the curable composition for a bonded magnet is not particularly limited as long as the desired fluidity at the time of molding may be ensured. In one aspect of the present embodiment, the content of the magnetic powder in the curable composition for a bonded magnet is preferably less than 95 mass %, and more preferably 93 mass % or less. When the content of the magnetic powder in the curable composition for a bonded magnet is less than 95 mass % and more preferably 93 mass % or less, the curable composition may be easily molded by an injection molding method, a transfer molding method, or the like in general. The content of the magnetic powder in the curable composition for a bonded magnet is not particularly limited, but from the viewpoint of the magnetic properties of the bonded magnet to be obtained, the content thereof is preferably 80 mass % or more, and more preferably 85 mass % or more.

### Epoxy Resin (Main Agent)

The curable composition for a bonded magnet according to the present embodiment comprises, as an epoxy resin (main agent), at least one selected from a phenol novolac-type epoxy resin, a cresol novolac-type epoxy resin, and a triphenylmethane-type epoxy resin. A single type of these epoxy resins may be used, or two or more types of these may be used in combination.

The phenol novolac-type epoxy resin comprises a repeating unit represented by the following formula (1-1), and may comprise one or more types of other repeating units. In the phenol novolac-type epoxy resin, the proportion of the repeating unit represented by the following formula (1-1) in all the repeating units is preferably 50 mol % or more, and more preferably 60 mol % or more. The repeating unit other than the repeating unit represented by formula (1-1) is not particularly limited and may be appropriately selected.

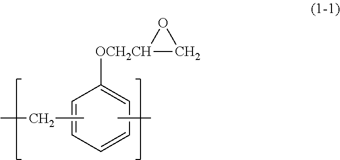

The cresol novolac-type epoxy resin comprises a repeating unit represented by the following formula (1-2), and may comprise one or more types of other repeating units. In the cresol novolac-type epoxy resin, the proportion of the repeating unit represented by the following formula (1-2) in all the repeating units is preferably 50 mol % or more, and more preferably 60 mol % or more. The repeating unit other than the repeating unit represented by formula (1-2) is not particularly limited and may be appropriately selected.

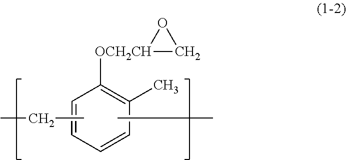

The triphenylmethane-type epoxy resin comprises a repeating unit represented by the following formula (1-3), and may comprise one or more types of other repeating units. In the triphenylmethane-type epoxy resin, the proportion of the repeating unit represented by the following formula (1-3) in all the repeating units is preferably 50 mol % or more, and more preferably 60 mol % or more. The repeating unit other than the repeating unit represented by formula (1-3) is not particularly limited and may be appropriately selected.

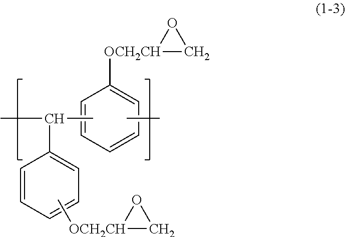

In the present embodiment, the epoxy resin (main agent) is usually preferably composed of any one or more of the repeating unit represented by the above formula (1-1), the repeating unit represented by the above formula (1-2), and the repeating unit represented by the above formula (1-3), and in this case, the proportion of each repeating unit in all the repeating units may be 50 mol % or less. Among these, a phenol novolac-type epoxy resin consisting only of the repeating unit represented by the above formula (1-1), a cresol novolac-type epoxy resin consisting only of the repeating unit represented by the above formula (1-2), and a triphenylmethane-type epoxy resin consisting only of the repeating unit represented by the above formula (1-3) are preferable, a cresol novolac-type epoxy resin consisting only of the repeating unit represented by the above formula (1-2) and a triphenylmethane-type epoxy resin consisting only of the repeating unit represented by the above formula (1-3) are more preferable, and a triphenylmethane-type epoxy resin consisting only of the repeating unit represented by the above formula (1-3) is still more preferable.

In the present embodiment, from the viewpoints of a high curing rate, good moldability, and high heat resistance and oil resistance of the obtained bonded magnet, the epoxy equivalents of the phenol novolac-type epoxy resin, the cresol novolac-type epoxy resin, and the triphenylmethane-type epoxy resin are preferably 250 g/eq or less, more preferably 230 g/eq or less, more preferably 220 g/eq or less, and even more preferably 210 g/eq or less. The lower limit of the epoxy equivalents of these epoxy resins is not particularly limited, but is usually about 140 g/eq.

From the viewpoint of moldability, the epoxy resin (main agent) usually has a softening point of preferably 100° C. or lower, and more preferably 85° C. or lower. The lower limit of the softening point of the epoxy resin (main agent) is not particularly limited, but is preferably 40° C. or higher from the viewpoint of storage stability at room temperature.

Commercially available products may be used as the phenol novolac-type epoxy resin, the cresol novolac-type epoxy resin, and the triphenylmethane-type epoxy resin having epoxy equivalents of 250 g/eq or less. Examples of commercially available phenol novolac-type epoxy resins having an epoxy equivalent that is 250 g/eq or less include EPICLON N-740, N-770, and N-775 (all available from DIC Corporation). Examples of commercially available cresol novolac-type epoxy resins having an epoxy equivalent that is 250 g/eq or less include N-660, N-673, and N-695 (all available from DIC Corporation), and YDCN-700-7 and YDCN-704A (both available from Nippon Steel Chemical & Material Co., Ltd.). Examples of commercially available triphenylmethane-type epoxy resins having an epoxy equivalent that is 250 g/eq or less include EPPN-501H and EPPN-502H (both available from Nippon Kayaku Co., Ltd.).

The curable composition for a bonded magnet of the present embodiment preferably comprises, as an epoxy resins which is a main agent, only at least one of a phenol novolac-type epoxy resin, a cresol novolac-type epoxy resin, or a triphenylmethane-type epoxy resin, each of which preferably has an epoxy equivalent that is 250 g/eq or less (these epoxy resins may be a single type or two or more types). However, the curable composition thereof may comprise other epoxy resins other than these epoxy resins, or an epoxy compound (monomer and the like) that forms an epoxy resin by curing. For example, the curable composition may comprise a biphenyl aralkyl-type epoxy resin or the like. In the curable composition for a bonded magnet of the present embodiment, the content (proportion) of the other epoxy resin or epoxy compound in relation to all of the epoxy resins (main agents) is preferably 5 mass % or less, more preferably 1 mass % or less, and particularly preferably 0 mass %.

### Curing Agent

The curable composition for a bonded magnet according to the present embodiment comprises, as a curing agent, at least one selected from a novolac-type phenolic resin, a cresol novolac-type phenolic resin, and a triphenylmethane-type phenolic resin. A single type of these phenolic resin-based curing agents may be used, or two or more types of these may be used in combination.

The novolac-type phenolic resin comprises a repeating unit represented by the following formula (2-1), and may comprise one or more types of other repeating units. In the novolac-type phenolic resin, the proportion of the repeating unit represented by the following formula (2-1) in all the repeating units is preferably 50 mol % or more, and more preferably 60 mol % or more. The repeating unit other than the repeating unit represented by formula (2-1) is not particularly limited and may be appropriately selected.

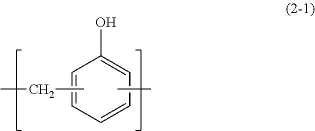

The cresol novolac-type phenolic resin comprises a repeating unit represented by the following formula (2-2), and may comprise one or more types of other repeating units. In the cresol novolac-type phenolic resin, the proportion of the repeating unit represented by the following formula (2-2) in all the repeating units is preferably 50 mol % or more, and more preferably 60 mol % or more. The repeating unit other than the repeating unit represented by formula (2-2) is not particularly limited and may be appropriately selected.

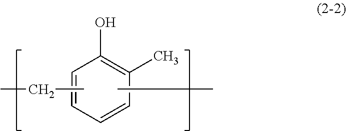

The triphenylmethane-type phenolic resin comprises a repeating unit represented by the following formula (2-3), and may comprise one or more types of other repeating units. In the triphenylmethane-type phenolic resin, the proportion of the repeating unit represented by the following formula (2-3) in all the repeating units is preferably 50 mol % or more, and more preferably 60 mol % or more. The repeating unit other than the repeating unit represented by formula (2-3) is not particularly limited and may be appropriately selected.

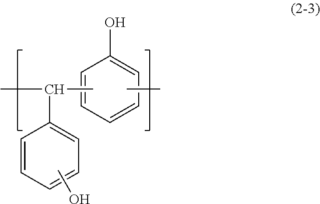

In the present embodiment, the curing agent is usually preferably composed of any one or more of the repeating unit represented by the above formula (2-1), the repeating unit represented by the above formula (2-2), and the repeating unit represented by the above formula (2-3), and in this case, the proportion of each repeating unit in all the repeating units may be 50 mol % or less. Among these, a novolac-type phenolic resin consisting of only the repeating unit represented by the above formula (2-1), a cresol novolac-type phenolic resin consisting of only the repeating unit represented by the above formula (2-2), and a triphenylmethane-type phenolic resin consisting of only the repeating unit represented by the above formula (2-3) are preferable, and a novolac-type phenolic resin consisting of only the repeating unit represented by the above formula (2-1) is more preferable.

In one aspect of the present embodiment, a combination of a triphenylmethane-type epoxy resin (main agent) consisting only of the repeating unit represented by the above formula (1-3), and a novolac-type phenolic resin (curing agent) consisting only of the repeating unit represented by the above formula (2-1) may be particularly preferable.

In the present embodiment, from the viewpoints of a high curing rate, good moldability, and high heat resistance and oil resistance of the obtained bonded magnet, the hydroxyl equivalents of the novolac-type phenolic resin, the cresol novolac-type phenolic resin, and the triphenylmethane-type phenolic resin are preferably 150 g/eq or less, more preferably 140 g/eq or less, even more preferably 130 g/eq or less, and still more preferably 120 g/eq or less. The lower limit of the hydroxyl equivalent of these phenolic resin-based curing agents is not particularly limited, but is usually about 70 g/eq.

From the viewpoint of moldability, the softening point of the phenolic resin-based curing agent is usually preferably 100° C. or lower, and more preferably 85° C. or lower. The lower limit of the softening point of the phenolic resin-based curing agent is not particularly limited, but is preferably 40° C. or higher from the viewpoint of storage stability at room temperature.

Commercially available products may also be used as the novolac-type phenolic resin, the cresol novolac-type phenolic resin, and the triphenylmethane-type phenolic resin having hydroxyl equivalents of 150 g/eq or less. Examples of commercially available novolac-type phenolic resins having a hydroxyl equivalent that is 150 g/eq or less include TD-2131 and TD-2106 (both available from DIC Corporation). Examples of commercially available cresol novolac-type phenolic resins having a hydroxyl equivalent that is 150 g/eq or less include KA-1160, KA-1163, and KA-1165 (all available from DIC Corporation). Examples of commercially available triphenylmethane-type phenolic resins having a hydroxyl equivalent that is 150 g/eq or less include MEH-7500 (available from UBE Corporation), S-TPM-130 and S-TPM-113 (both available from JFE Chemical Corporation), and KAYAHARD KTG-105 (available from Nippon Kayaku Co., Ltd.).

The curable composition for a bonded magnet of the present embodiment preferably comprises, as a curing agent, only at least one of a novolac-type phenolic resin, a cresol novolac-type phenolic resin, or a triphenylmethane-type phenolic resin, each of which preferably has a hydroxyl equivalent that is 150 g/eq or less (these phenolic resin-based curing agents may be a single type or two or more types), but may comprise a curing agent other than these. For example, the curable composition may comprise at least one phenolic resin-based curing agent other than the novolac-type phenolic resin, the cresol novolac-type phenolic resin, and the triphenylmethane-type phenolic resin. In the curable composition for a bonded magnet of the present embodiment, the content (proportion) of the other curing agent in relation to all of the curing agents is preferably 5 mass % or less, more preferably 1 mass % or less, and particularly preferably 0 mass %.

The content of the novolac-type phenolic resin, the cresol novolac-type phenolic resin, and the triphenylmethane-type phenolic resin (curing agents), each of which preferably has a hydroxyl equivalent that is 150 g/eq or less, in the curable composition for a bonded magnet is not particularly limited and may be appropriately selected according to the types of the epoxy resin, curing agent, and curing accelerator to be used. In one aspect of the present embodiment, the content of the novolac-type phenolic resin, the cresol novolac-type phenolic resin, and the triphenylmethane-type phenolic resin, each of which has a hydroxyl equivalent that is preferably 150 g/eq or less, in the curable composition for a bonded magnet is, for example, preferably in a range of 30 to 90 parts by mass, and more preferably in a range of 40 to 65 parts by mass, per 100 parts by mass of the epoxy resin (main agent).

Curing Accelerator The curable composition for a bonded magnet according to the present embodiment may further comprise a curing accelerator. When the curable composition for a bonded magnet comprises a curing accelerator, the molding temperature (curing temperature of the composition) may be lowered, or the molding time (curing time of the composition) may be shortened. A single type of curing accelerator may be used, or two or more types may be used in combination.

The curing accelerator is not particularly limited, and examples thereof include urea-based curing accelerators such as dimethylurea, tertiary amine-based curing accelerators, imidazole-based curing accelerators, and aromatic amine-based curing accelerators.

A commercially available product may also be used as the curing accelerator. Examples of commercially available urea-based curing accelerators include U-cat 3512T and U-cat 3513N (both available from San-Apro Ltd.), and Dyhard UR200 and UR300 (both available from AlzChem Group AG). Examples of commercially available imidazole-based curing accelerators include Curezol 2E4MZ-A and 2PHZ-PW (both available from Shikoku Chemicals Corporation).

The content of the curing accelerator in the curable composition for a bonded magnet is not particularly limited and may be appropriately selected according to the types of the epoxy resin, curing agent, and curing accelerator to be used. In one aspect of the present embodiment, the content of the curing accelerator in the curable composition for a bonded magnet may be, for example, in a range of 0.5 to 5 parts by mass per 100 parts by mass of the epoxy resin (main agent).

The curing accelerator may be comprised in the curable composition for a bonded magnet before a step of curing and molding the curable composition for a bonded magnet, may be added to the curable composition for a bonded magnet immediately before the curable composition for a bonded magnet is heated and softened in the step of curing and molding the curable composition for a bonded magnet, or may be added to the curable composition for a bonded magnet at any time during the heating and softening of the curable composition for a bonded magnet.

### Phosphate Ester

The curable composition for a bonded magnet according to the present embodiment may further comprise a phosphate ester. A single type of phosphate ester may be used, or two or more types may be used in combination. As described above, through the addition of a phosphate ester, a rapid progression of the curing reaction of the epoxy resin may be suppressed particularly in injection molding and transfer molding, and better moldability may be achieved. In addition, the average particle size of the Sm—Fe—N-based magnetic powder is preferably smaller than that of other rare earth magnetic powders from the viewpoint of magnetic properties, but the effect of improving moldability by adding the phosphate ester tends to be more remarkable in a case in which the Sm—Fe—N-based magnetic powder is used as the magnetic powder. Even when the curable composition does not comprise a phosphate ester, while the moldability of the bonded magnet is inferior, a bonded magnet may be obtained by compression molding for example, and the obtained bonded magnet exhibits good heat resistance and oil resistance.

From the viewpoint of achieving a high effect of improving moldability, the phosphate ester is preferably an alkyl ether phosphate, more preferably a polyoxyethylene alkyl ether phosphate, and even more preferably a polyoxyethylene alkyl ether phosphate represented by the following formula (3-1).

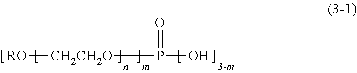

In the formula, R represents an alkyl group, n represents an integer of 1 or greater, and m represents an integer in a range of 1 to 3.

The alkyl group contained in the alkyl ether phosphate or in the polyoxyethylene alkyl ether phosphate may be linear or branched, and the number of carbon atoms thereof is not particularly limited, but is preferably 8 or more, and more preferably in a range of 8 to 24.

R in formula (3-1) is also preferably a linear or branched alkyl group having 8 or more carbon atoms, and is more preferably a linear or branched alkyl group having carbons in a range of 8 to 24.

In formula (3-1), n represents an integer of 1 or greater, preferably an integer in a range of 1 to 4, and more preferably an integer of 1 or 2.

In formula (3-1), m represents an integer in a range of 1 to 3. That is, the polyoxyethylene alkyl ether phosphate represented by formula (3-1) may be a phosphate monoester, a phosphate diester, or a phosphate triester. A single type of polyoxyethylene alkyl ether phosphate may be used, or two or more types may be used in combination.

A commercially available product may also be used as the phosphate ester, and preferably as the polyoxyethylene alkyl ether phosphate. Examples of commercially available polyoxyethylene alkyl ether phosphates include Phosphanol RS-410, RS-610, and RS-710 (all available from Toho Chemical Industry Co., Ltd.), and lauryl EO2 acid phosphate and oleyl EO2 acid phosphate (all available from Johoku Chemical Co., Ltd.).

The content of the phosphate ester in the curable composition for a bonded magnet is not particularly limited and may be appropriately selected according to the types of the magnetic powder, epoxy resin, and curing agent to be used, and the like. In one aspect of the present embodiment, the content of the phosphate ester in the curable composition for a bonded magnet is, for example, preferably in a range of 0.05 to 1 part by mass, and more preferably in a range of 0.1 to 0.6 parts by mass, per 100 parts by mass of the magnetic powder.

### Magnetic Powder

In the curable composition for a bonded magnet of the present embodiment, the magnetic powder is not particularly limited, and any known magnetic powder such as ferrite powder and a rare earth magnetic powder may be suitably used. A single type of magnetic powder may be used, or two or more types thereof may be used in combination.

In one aspect of the present embodiment, a rare earth magnetic powder is preferable because of having good magnetic properties. Examples of the rare earth magnetic powder include Sm—Co-based, Nd—Fe—B-based, and Sm—Fe—N-based magnetic powders. In the present embodiment, any rare earth magnetic powder may be suitably used without particular limitation, but a Sm—Fe—N-based magnetic powder is particularly preferable from the viewpoints of the magnetic properties, heat resistance, and oil resistance of the obtained bonded magnet and the moldability of the bonded magnet. The Sm—Fe—N magnetic powder exhibits high corrosion resistance and also heat resistance due to a high anisotropic magnetic field exceeding 260 kOe (20.7 MA/m), and also has good heat resistance and oil resistance. A single type of rare earth magnetic powder may be used, or two or more types thereof may be used in combination.

The Sm—Co-based magnetic powder may be produced by, for example, a method disclosed in JP 08-260083 A. The Nd—Fe—B-based magnetic powder may be produced by, for example, the hydrogenation disproportionation desorption and recombination (HDDR) process disclosed in WO 2003/85147. The Sm—Fe—N-based magnetic powder may be produced by, for example, a method disclosed in JP 11-189811 A.

As described above, in one aspect of the present embodiment, the rare earth magnetic powder is preferably a Sm—Fe—N-based magnetic powder. Examples of the Sm—Fe—N-based magnetic powder are nitrides that have a Th₂Zn₁₇ type crystal structure, are formed from the rare earth metal samarium (Sm), iron (Fe), and nitrogen (N), and are represented by the general formula SmₓFe_{100-x-y}N_{y}. Here, preferably, x is in a range of 8.1 atom % to 10 atom %, y is in a range of 13.5 atom % to 13.9 atom %, and the balance is mainly Fe.

The rare earth magnetic powder may be used as is, but may also be used after being subjected to a surface treatment with a silane coupling agent or the like. The surface treatment with a silane coupling agent or the like may be performed by, for example, the method disclosed in JP 2017-43804 A.

In the case of a Sm—Fe—N-based magnetic powder, a powder having a phosphate coating formed on the surface, that is, a phosphate-coated Sm—Fe—N-based magnetic powder, may be used. The phosphate-coated Sm—Fe—N-based magnetic powder may be produced by, for example, a method disclosed in WO 2022/107462, JP 2023-96735 A, JP 2024-51932 A, or the like.

The average particle size of the rare earth magnetic powder may be appropriately selected according to the type thereof, and is not particularly limited. In the case of the Sm—Co-based magnetic powder, the average particle size is usually preferably in a range of 10 μm to 250 μm. In the case of the Nd—Fe—B-based magnetic powder, the average particle size is usually preferably in a range of 10 μm to 250 μm. In the case of the Sm—Fe—N-based magnetic powder, the average particle size is usually preferably in a range of 2 μm to 5 μm, and more preferably in a range of 2.5 μm to 4.8 μm. When the average particle size is 2 μm or greater, the filling amount of the Sm—Fe—N-based magnetic powder in the bonded magnet may be increased, and the magnetization may be improved. In addition, when the average particle size is 5 μm or smaller, the intrinsic coercivity of the bonded magnet may be improved. Here, the average particle size is a particle size measured in dry conditions using a laser diffraction-type particle size distribution measurement device.

The particle size D50 in the case of the Sm—Fe—N-based magnetic powder is preferably in a range of 2.5 μm to 5 μm, and is more preferably in a range of 2.7 am to 4.8 μm. The particle size D10 is preferably in a range of 1 μm to 3 μm, and more preferably in a range of 1.5 μm to 2.5 μm. Moreover, the particle size D90 is preferably in a range of 3 μm to 7 μm, and more preferably in a range of 4 μm to 6 μm. D50 is the particle size at which the integrated value of the volume-based particle size distribution of the Sm—Fe—N-based magnetic powder is equivalent to 50%. D10 is the particle size at which the integrated value of the volume-based particle size distribution of the Sm—Fe—N-based magnetic powder is equivalent to 10%. D90 is the particle size at which the integrated value of the volume-based particle size distribution of the Sm—Fe—N-based magnetic powder is equivalent to 90%.

A span, defined as span=(D90−D10)/D50, of the Sm—Fe—N-based magnetic powder is preferably 2 or less, and more preferably 1.5 or less from the perspective of the coercivity of the bonded magnet.

The circularity of the Sm—Fe—N-based magnetic powder is not particularly limited, but is preferably 0.5 or higher, and more preferably 0.6 or higher. When the circularity is less than 0.5, fluidity worsens, and thereby stress is applied between particles at the time of molding, and thus the magnetic properties may be reduced. Here, to measure circularity, an SEM image captured at 3000× is binarized through image processing, and the circularity of one particle is determined. The circularity stipulated here refers to an average value of circularity determined by measuring approximately 1000 to 10000 particles. In general, the circularity increases as the number of particles having a small particle size increases, and therefore the circularity is measured for particles having a particle size of 1 μm or greater. In the measurement of circularity, a definitional equation of circularity=(4πS/L²) is used. Here, S is the two-dimensional projected area of the particle, and L is the two-dimensional projected circumferential length.

### Sm—Fe—N-Based Magnetic Powder

In one aspect of the present embodiment, the Sm—Fe—N-based magnetic powder is preferably anisotropic from the viewpoint of the magnetic properties of the obtained bonded magnet. In addition, the Sm—Fe—N-based magnetic powder may be preferably coated with a phosphate on the surface thereof from the viewpoint of improving the coercivity, heat resistance, and oil resistance.

Hereinafter, an example of a method for producing a Sm—Fe—N-based anisotropic magnetic powder and an example of a method for producing a phosphate-coated Sm—Fe—N-based anisotropic magnetic powder according to the present embodiment will be described, but the present disclosure is not limited to the following embodiments, and the magnetic powders thereof may be produced by other production methods.

### Method for Producing Sm—Fe—N-Based Anisotropic Magnetic Powder

The method for producing a Sm—Fe—N-based anisotropic magnetic powder is not particularly limited, but, for example, the Sm—Fe—N-based anisotropic magnetic powder may be produced by a method comprising: a step (precipitation step) of mixing a solution comprising Sm and Fe and a precipitant to form a precipitate comprising Sm and Fe; a step (oxidation step) of firing the precipitate to form an oxide comprising Sm and Fe; a step (pretreatment step) of heat treating the oxide in an environment comprising a reducing gas to form a partial oxide; a step (reduction step) of reducing the partial oxide; and a step (nitriding step) of subjecting alloy particles formed in the reduction step to nitriding.

### Precipitation Step

In the precipitation step, a solution comprising Sm and Fe is prepared by dissolving a Sm raw material and an Fe raw material in a strongly acidic solution. When Sm₂Fe₁₇N₃ is formed as the main phase, the molar ratio of Sm to Fe (Sm:Fe) is preferably in a range of 1.5:17 to 3.0:17, and more preferably in a range of 2.0:17 to 2.5:17. A raw material such as La, W, Co, Ti, Sc, Y, Pr, Nd, Pm, Gd, Tb, Dy, Ho, Er, Tm, or Lu may be added to the solution.

The Sm raw material and the Fe raw material are not limited as long as they can be dissolved in the strongly acidic solution. For example, from the viewpoint of availability, examples of the Sm raw material include samarium oxide, and examples of the Fe raw material include FeSO₄. The concentration of the solution comprising Sm and Fe may be appropriately adjusted within a range in which the Sm raw material and the Fe raw material are substantially dissolved in the acidic solution. From the perspective of solubility, an example of the acidic solution includes sulfuric acid.

An insoluble precipitate comprising Sm and Fe is formed by reacting the solution comprising Sm and Fe with a precipitant. Here, the solution comprising Sm and Fe need only be a solution comprising Sm and Fe when reacted with the precipitant, and, for example, raw materials comprising Sm and Fe may be prepared as separate solutions, and each solution may be added dropwise to react with the precipitant. Even when the raw materials are prepared as separate solutions, appropriate adjustments are made within a range in which each raw material is substantially dissolved in the acidic solution. The precipitant is not limited as long as it is an alkaline solution that reacts with the solution comprising Sm and Fe to produce a precipitate. Examples of the precipitant include ammonia water and caustic soda, and caustic soda is preferable.

As the precipitation reaction, a method in which the precipitant and the solution comprising Sm and Fe are each added dropwise to a solvent such as water is preferable because the properties of the precipitate particles may be easily adjusted. The supply rates of the precipitant and the solution comprising Sm and Fe, the reaction temperature, the reaction solution concentration, the pH during the reaction, and the like are appropriately controlled, and thereby a precipitate having a uniform distribution of constituent elements, a sharp particle size distribution, and a uniform powder shape is formed. The magnetic properties of the magnetic powder that is the final product are improved by using such a precipitate. The reaction temperature is preferably set in a range of 0 to 50° C., and is more preferably set in a range of 35 to 45° C. As a total concentration of metal ions, the reaction solution concentration is preferably in a range of 0.65 to 0.85 mol/L, and more preferably in a range of 0.7 to 0.84 mol/L. The reaction pH is preferably in a range of 5 to 9, and more preferably in a range of 6.5 to 8.

The powder particle size, powder shape, and particle size distribution of the magnetic powder that is ultimately formed is generally determined by the particle powder obtained in the precipitation step. The powder is preferably of a size and distribution such that when the particle size of the formed particles is measured using a laser diffraction-type wet particle size distribution meter, the particle size of all of the powder is substantially within a range of 0.05 μm to 20 μm, and more preferably within a range of 0.1 μm to 10 μm. Additionally, the average particle size of the particles is measured as a particle size corresponding to a cumulative volume of 50% from the small particle size side in the particle size distribution, and is preferably within a range of 0.1 μm to 10 μm.

After the precipitate is separated, the solvent is preferably removed from the separated product, in order to suppress aggregation of the precipitate and changes in the particle size distribution, the particle size of the powder, or the like when the precipitate is redissolved in the remaining solvent and the solvent evaporates in the heat treatment of the subsequent oxidation step. When, for example, water is used as the solvent, a specific example of the method for removing the solvent comprises drying in an oven at a temperature in a range of 70° C. to 200° C. for a time in a range of 5 hours to 12 hours.

The method for producing a Sm—Fe—N-based anisotropic magnetic powder may comprise, after the precipitation step, steps of separating and washing the resulting precipitate. The washing step is appropriately performed until the conductivity of a supernatant solution becomes 5 mS/m² or less. As the step of separating the precipitate, for example, a filtration method, a decantation method, or the like may be used after a solvent (preferably water) is added to the formed precipitate and mixed.

### Oxidation Step

The oxidation step is a step of calcining the precipitate formed in the precipitation step to form an oxide comprising Sm and Fe. For example, the precipitate may be converted to an oxide by heat treatment. When the precipitate is subjected to heat treatment, the heat treatment must be implemented in the presence of oxygen, and for example, the heat treatment may be performed in an air atmosphere. Also, because the heat treatment must be performed in the presence of oxygen, oxygen atoms are preferably comprised in a non-metal portion in the precipitate.

The heat treatment temperature (hereinafter, also referred to as the oxidation temperature) in the oxidation step is not particularly limited, but is preferably in a range of 700° C. to 1300° C., and more preferably in a range of 900° C. to 1200° C. At a temperature of less than 700° C., the oxidation may be insufficient, and when the temperature exceeds 1300° C., the targeted shape, average particle size, and particle size distribution of the magnetic powder tend not to be obtained. The heat treatment time is also not particularly limited, but is preferably in a range of 1 hour to 3 hours.

The formed oxide is oxide particles in which Sm and Fe are sufficiently mixed microscopically in the oxide particles, and the shape, the particle size distribution, and the like of the precipitate are reflected.

### Pretreatment Step

The pretreatment step is a step of heat treating an oxide comprising Sm and Fe in a reducing gas atmosphere to form a partial oxide in which a portion of the oxide is reduced.

Here, the partial oxide refers to an oxide in which a portion of the oxide is reduced. The oxygen concentration in the oxide is not particularly limited, but is preferably 10 mass % or less, and more preferably 8 mass % or less. When the oxygen concentration exceeds 10 mass %, the heat generated during the reduction with Ca increases in the reduction step, and the calcining temperature increases, whereby particles with abnormal particle growth tend to be easily formed. Here, the oxygen concentration of the partial oxide may be measured by a non-dispersive infrared absorption method (ND-IR).

The reducing gas is appropriately selected from hydrogen (H₂), carbon monoxide (CO), hydrocarbon gases such as methane (CH₄), and the like, but in terms of cost, hydrogen gas is preferable. The flow rate of the gas is appropriately adjusted within a range in which the oxide does not scatter. The heat treatment temperature (hereinafter, may also be referred to as the pretreatment temperature) in the pretreatment step is preferably in a range of 300° C. to 950° C., more preferably 400° C. or higher, and particularly preferably 750° C. or higher, and is also more preferably lower than 900° C. When the pretreatment temperature is 300° C. or higher, the reduction of the oxide comprising Sm and Fe proceeds efficiently. Moreover, when the pretreatment temperature is 950° C. or lower, particle growth and segregation of the oxide particles may be suppressed, and the desired particle size may be easily maintained.

### Reduction Step

The reduction step is a step of, for example, subjecting the partial oxide obtained in the pretreatment step to, for example, a heat treatment at a temperature in a range of preferably from 920 to 1200° C. in the presence of a reducing agent to thereby obtain alloy particles. For example, reduction is performed by bringing the partial oxide into contact with molten calcium or a calcium vapor. From the perspective of magnetic properties, the heat treatment temperature is preferably in a range of 950° C. to 1150° C., and more preferably in a range of 980° C. to 1100° C. From the viewpoint of suppressing non-uniform particle growth, the heat treatment time is preferably less than 120 minutes, and more preferably less than 90 minutes. From the perspective of a more uniform reduction reaction, the heat treatment time is preferably 10 minutes or longer, and more preferably 30 minutes or longer.

Metal calcium may be used, for example, in a granular or powdered form, and the particle size of the metal calcium is preferably 10 mm or less. Using metal calcium with the particle size of preferably 10 mm or less may suppress aggregation more effectively during the reduction reaction. Furthermore, the metal calcium may be added, for example, in an amount of from 1.1 times to 3.0 times the reaction equivalent (the stoichiometric amount required to reduce the Sm oxide, and when Fe is in the form of an oxide, the reaction equivalent includes the amount necessary to reduce the Fe oxide), and is preferably added in an amount of from 1.5 times to 2.0 times the reaction equivalent.

In the reduction step, a disintegration accelerator may be used as necessary along with metal calcium, which is a reducing agent. This disintegration accelerator is appropriately used to promote disintegration and granulation of products during a rinsing step described below, and examples of the disintegration accelerator include alkaline earth metal salts such as calcium chloride, and alkaline earth metal oxides such as calcium oxide. These disintegration accelerators are used, for example, at a proportion in a range of 1 mass % to 30 mass %, and preferably in a range of 5 mass % to 28 mass %, per the Sm oxide used as the Sm source.

### Nitriding Step

The nitriding step is a step of subjecting the alloy particles formed in the reduction step to nitriding, thereby forming a Sm—Fe—N-based anisotropic magnetic powder. With the present method, the porous clump-shaped product comprising alloy particles and obtained in the reduction step is immediately heat treated in a nitrogen atmosphere, and the alloy particles are nitrided without being subjected to grinding, thus enabling uniform nitriding.

The heat treatment temperature (hereinafter, may also be referred to as the nitriding temperature) for nitriding the alloy particles is preferably in a range of 300° C. to 600° C., and particularly preferably in a range of 400° C. to 550° C., and nitriding is performed by replacing the atmospheric air with a nitrogen atmosphere in this temperature range. The heat treatment time needs only to be set to a time that allows the alloy particles to be sufficiently and uniformly nitrided.

The product formed after the nitriding step comprises, in addition to the magnetic particles (Sm—Fe—N-based anisotropic magnetic powder), CaO as a byproduct, unreacted metal calcium, and the like, and these may be combined in a sintered bulk state. In this case, the product may be put into cooling water to separate the CaO and metal calcium as a calcium hydroxide (Ca(OH)₂) suspension from the magnetic particles. Furthermore, the magnetic particles may be washed with acetic acid or the like to sufficiently remove the remaining calcium hydroxide.

### Method for Producing Phosphate-Coated Sm—Fe—N-Based Anisotropic Magnetic Powder

The method for producing a phosphate-coated Sm—Fe—N-based anisotropic magnetic powder is not particularly limited, but, for example, the phosphate-coated Sm—Fe—N-based anisotropic magnetic powder may be produced by a method comprising: a phosphoric acid treatment step of adding an inorganic acid to a slurry comprising a Sm—Fe—N-based anisotropic magnetic powder, water, and a phosphoric acid compound to adjust the pH of the slurry to a range of preferably 1 to 4.5 and thereby form a Sm—Fe—N-based anisotropic magnetic powder having a surface coated with a phosphate; and an oxidation step of heat treating the phosphate-coated Sm—Fe—N-based anisotropic magnetic powder in an oxygen-comprising atmosphere at a temperature in a range preferably from 200° C. to 330° C.

### Phosphoric Acid Treatment Step

In the phosphoric acid treatment step, an inorganic acid is added to a slurry comprising a Sm—Fe—N-based anisotropic magnetic powder, water, and a phosphoric acid compound, and the pH of the slurry is adjusted preferably to a range of 1 to 4.5, and thereby a Sm—Fe—N-based anisotropic magnetic powder having a surface coated with a phosphate is obtained. The phosphate-coated Sm—Fe—N-based anisotropic magnetic powder is formed by reacting a metal component (for example, iron or samarium) comprised in the Sm—Fe—N-based anisotropic magnetic powder and a phosphoric acid component comprised in the phosphoric acid compound, and thereby depositing a phosphate (for example, iron phosphate or samarium phosphate) on the surface of the Sm—Fe—N-based anisotropic magnetic powder. In comparison with a case in which an inorganic acid is not added, the amount of the phosphate deposited may be increased by adding an inorganic acid to adjust the pH of the slurry to a range of 1 to 4.5, and therefore a phosphate-coated Sm—Fe—N-based anisotropic magnetic powder in which the thickness of the coating portion is thick may be formed. Furthermore, there is a tendency that, in comparison to a case in which an organic solvent is used as the solvent, a phosphate having a small particle size is deposited, and therefore a phosphate-coated Sm—Fe—N-based anisotropic magnetic powder in which the coating portion is dense is formed by using water as the solvent.

The method for producing a slurry comprising a Sm—Fe—N-based anisotropic magnetic powder, water, and a phosphoric acid compound is not particularly limited, but for example, the slurry may be formed by using water as a solvent and mixing the Sm—Fe—N-based anisotropic magnetic powder with an aqueous phosphoric acid solution comprising a phosphoric acid compound. The content of the Sm—Fe—N-based anisotropic magnetic powder in the slurry is, for example, preferably in a range of 1 mass % to 50 mass %, and from the perspective of productivity, the content thereof is more preferably in a range of 5 mass % to 20 mass %. The content of the phosphoric acid component (PO₄) in the slurry in terms of the amount of PO₄ is, for example, preferably in a range of 0.01 mass % to 10 mass %, and from the perspectives of productivity and reactivity of the phosphoric acid component, the content thereof is more preferably in a range of 0.05 mass % to 5 mass %.

The aqueous phosphoric acid solution is formed by mixing a phosphoric acid compound and water. Examples of the phosphoric acid compound include phosphate-based compounds, such as ortho-phosphoric acid, sodium dihydrogen phosphate, sodium hydrogen phosphate, ammonium dihydrogen phosphate, ammonium monohydrogen phosphate, zinc phosphate, and calcium phosphate, hypophosphorous acid-based compounds, hypophosphite-based compounds, pyrophosphoric acid-based compounds, polyphosphoric acid-based compounds, and other such inorganic phosphoric acids, and organic phosphoric acids. A single type of these phosphoric acid compounds may be used, or a combination of two or more may be used. In addition, an oxoacid such as molybdate, tungstate, vanadate, and chromate, an oxidant such as sodium nitrate and sodium nitrite, and a chelating agent such as EDTA may be further added for the purpose of improving the water resistance and corrosion resistance obtained through the coating, and the magnetic properties of the magnetic powder.

The concentration (in terms of the amount of PO₄) of the phosphoric acid in the aqueous phosphoric acid solution is, for example, preferably in a range of 5 mass % to 50 mass %, and from the perspectives of the solubility of the phosphoric acid compound, storage stability, and ease of oxidation, the concentration thereof is more preferably in a range of 10 mass % to 30 mass %. The pH of the aqueous phosphoric acid solution is, for example, preferably in a range of 1 to 4.5, and from the perspective of facilitating control of the deposition rate of the phosphate, the pH thereof is more preferably in a range of 1.5 to 4. The pH may be adjusted using dilute hydrochloric acid, dilute sulfuric acid, or the like.

In the phosphoric acid treatment step, an inorganic acid is added to adjust the pH of the slurry to preferably a range of 1 to 4.5, more preferably to a range of 1.6 to 3.9, and even more preferably to a range of 2 to 3. If the pH is less than 1, a large amount of the phosphate is locally deposited, causing aggregation of the phosphate-coated Sm—Fe—N-based anisotropic magnetic powder, which may lead to decrease in coercivity. If the pH exceeds 4.5, the amount of phosphate deposited decreases, leading to an insufficient coating, and as a result, the coercivity may decrease. Examples of the inorganic acid that is added include hydrochloric acid, nitric acid, sulfuric acid, boric acid, and hydrofluoric acid. During the phosphoric acid treatment step, the inorganic acid is added as needed such that the pH is within the range described above. An inorganic acid is preferably used from the perspective of waste liquid disposal, but an organic acid may also be used in combination according to the purpose. Examples of the organic acid include acetic acid, formic acid, and tartaric acid. A mixed solution of an inorganic acid and an organic acid may be used.

The phosphate content of the phosphate-coated Sm—Fe—N-based anisotropic magnetic powder formed in the phosphoric acid treatment step is preferably greater than 0.5 mass %, more preferably 0.55 mass % or greater, and particularly preferably 0.75 mass % or greater. Moreover, the phosphate content of the phosphate-coated Sm—Fe—N-based anisotropic magnetic powder is preferably 4.5 mass % or less, more preferably 2.5 mass % or less, and particularly preferably 2 mass % or less. There is a tendency that the effect of coating with the phosphate is reduced when the phosphate content is 0.5 mass % or less. When the phosphate content exceeds 4.5 mass %, the phosphate-coated Sm—Fe—N-based anisotropic magnetic powder aggregates, and coercivity may decrease. Note that the phosphate content in the magnetic powder is expressed in terms of the amount of PO₄ molecules measured using inductively coupled plasma atomic emission spectroscopy (ICP-AES).

The pH of the slurry comprising a Sm—Fe—N-based anisotropic magnetic powder, water, and a phosphoric acid compound is adjusted to a range of 1 to 4.5 over a period of preferably 10 minutes or longer, and more preferably over a period of 30 minutes or longer from the perspective of reducing portions of the coating portion at which the thickness is thin. At the initial stage of pH maintenance, the pH rises rapidly, and therefore the interval between each introduction of the inorganic acid for pH control is short. However, as the coating progresses, changes in pH gradually slow down, and the interval between each introduction of the inorganic acid becomes longer, and therefore the reaction end point can be determined.

Oxidation Step after Phosphoric Acid Treatment

In the oxidation step after the phosphoric acid treatment, the phosphate-coated Sm—Fe—N-based anisotropic magnetic powder formed in the phosphoric acid treatment step is heat treated at a temperature in a range preferably from 200° C. to 330° C. in an oxygen-comprising atmosphere, and thereby the phosphate-coated Sm—Fe—N-based anisotropic magnetic powder is subjected to oxidation. By heat treating the phosphate-coated Sm—Fe—N-based anisotropic magnetic powder at a high temperature preferably in a range of 200° C. to 330° C. in an oxygen-comprising atmosphere, the surface of the Sm—Fe—N-based anisotropic magnetic powder as the base material and coated by the phosphate is oxidized, and a thick iron oxide layer is formed, and thereby the heat resistance and oil resistance of the phosphate-coated Sm—Fe—N-based anisotropic magnetic powder tend to improve.

The oxidation step after the phosphoric acid treatment is performed by heat treating the phosphate-coated Sm—Fe—N-based anisotropic magnetic powder in an oxygen-comprising atmosphere. The reaction atmosphere preferably comprises oxygen in an inert gas such as nitrogen or argon. The oxygen concentration is preferably in a range of 3% to 21%, and more preferably in a range of 3.5% to 10%. During the oxidation reaction, gas is preferably exchanged at a flow rate in a range of 2 L/min to 10 L/min per 1 kg of the magnetic powder.

The heat treatment temperature in the oxidation step after the phosphoric acid treatment is preferably in a range of 200° C. to 330° C., more preferably in a range of 200° C. to 250° C., and even more preferably in a range of 210° C. to 230° C. At a temperature of less than 200° C., production of the iron oxide layer becomes insufficient, and the effect of improving the heat resistance and oil resistance may decrease. When the temperature exceeds 330° C., the iron oxide layer is formed in excess, and the coercivity may decrease. The heat treatment time is, for example, preferably in a range of 3 hours to 10 hours.

The oxidation step after the phosphoric acid treatment is preferably implemented such that the phosphate coating portion present on the surface of the Sm—Fe—N-based anisotropic magnetic powder has a first region, the Sm atomic concentration in the first region is higher than the Sm atomic concentration in the Sm—Fe—N-based anisotropic magnetic powder, and the Sm atomic concentration in the first region is in a range of 0.5 times to 4 times an Fe atomic concentration in the first region. In relation to the Sm atomic concentration in the Sm—Fe—N-based anisotropic magnetic powder, the Sm atomic concentration in the first region may be, for example, 1.02 times or more, and is preferably 1.05 times or more, more preferably 1.1 times or more, and even more preferably 1.2 times or more. In addition, the Sm atomic concentration in the first region may be, for example, three times or less the Sm atomic concentration in the Sm—Fe—N-based anisotropic magnetic powder. The Sm atomic concentration in the first region is preferably, in relation to the Fe atomic concentration in the first region, in a range of 0.6 times to 3.5 times, and more preferably in a range of 0.7 times to 3 times. The atomic concentration (atm %) in the Sm—Fe—N-based anisotropic magnetic powder and in the first region is determined by averaging the atomic concentrations (atm %) in each region as determined from STEM-EDX line analysis.

### Silica Treatment Step

The Sm—Fe—N-based anisotropic magnetic powder (that is, the phosphate-coated Sm—Fe—N-based anisotropic magnetic powder) that has been subjected to the phosphoric acid treatment may be subjected to a silica treatment, as necessary, after the above oxidation step. Oxidation resistance may be improved by forming a silica thin film on the magnetic powder. The silica thin film may be formed, for example, by mixing an alkyl silicate, the phosphate-coated Sm—Fe—N-based anisotropic magnetic powder, and an alkaline solution.

### Silane Coupling Treatment Step

The magnetic powder after the silica treatment may be further treated with a silane coupling agent. A coupling agent film is formed on the silica thin film by subjecting the magnetic powder on which the silica thin film is formed to a silane coupling treatment, and thereby the magnetic properties of the magnetic powder may be improved, and wettability with a resin and the strength of the magnet may be improved.

The silane coupling agent is not particularly limited and may be selected in accordance with the type of resin, and examples of the silane coupling agent include 3-aminopropyl triethoxysilane, γ-(2-aminoethyl) aminopropyl trimethoxysilane, 7-(2-aminoethyl) aminopropylmethyl dimethoxysilane, γ-methacryloxypropyl trimethoxysilane, γ-methacryloxypropyl methyldimethoxysilane, N-3-(N-vinylbenzylaminoethyl)-γ-aminopropyl trimethoxysilane hydrochloride, γ-glycidoxypropyl trimethoxysilane, γ-glycidoxyoctyl trimethoxysilane, γ-mercaptopropyl trimethoxysilane, methyl trimethoxysilane, methyl triethoxysilane, vinyl triacetoxysilane, γ-chloropropyl trimethoxysilane, hexamethylene disilazane, γ-anilinopropyl trimethoxysilane, vinyl trimethoxysilane, octadecyl[3-(trimethoxysilyl)propyl]ammonium chloride, γ-chloropropylmethyl dimethoxysilane, γ-mercaptopropylmethyl dimethoxysilane, methyl trichlorosilane, dimethyl dichlorosilane, trimethylchlorosilane, vinyl trichlorosilane, vinyl tris(β-methoxyethoxy)silane, vinyl triethoxysilane, β-(3,4-epoxycyclohexyl)ethyl trimethoxysilane, γ-glycidoxypropylmethyl diethoxysilane, N-β(aminoethyl)γ-aminopropyl trimethoxysilane, N-β(aminoethyl)γ-aminopropylmethyl dimethoxysilane, γ-aminopropyl triethoxysilane, N-phenyl-γ-aminopropyl trimethoxysilane, oleidopropyl triethoxysilane, γ-isocyanatopropyl triethoxysilane, polyethoxydimethylsiloxane, polyethoxymethylsiloxane, bis(trimethoxysilylpropyl)amine, bis(3-triethoxysilylpropyl)tetrasulfane, γ-isocyanatopropyl trimethoxysilane, vinylmethyl dimethoxysilane, 1,3,5-N-tris(3-trimethoxysilylpropyl)isocyanurate, t-butylcarbamate trialkoxysilane, N-(1,3-dimethylbutylidene)-3-(triethoxysilyl)-1-propanamine, octyl triethoxysilane, octyl trimethoxysilane, decyl triethoxysilane, decyl trimethoxysilane, octadecyl triethoxysilane, octadecyl trimethoxysilane, and docosyl triethoxysilane. A single type of these silane coupling agents may be used, or two or more may be combined and used. The amount of the silane coupling agent added per 100 parts by mass of the magnetic powder is preferably in a range of 0.2 parts by mass to 0.8 parts by mass, and more preferably in a range of 0.25 parts by mass to 0.6 parts by mass. There is a tendency that the effect of the silane coupling agent is small when the amount of the silane coupling agent added is less than 0.2 parts by mass. When the amount of the silane coupling agent added exceeds 0.8 parts by mass, the magnetic properties of the magnetic powder and magnet tend may be reduced due to aggregation of the magnetic powder.

After the phosphoric acid treatment step, the oxidation step, the silica treatment, or the silane coupling treatment, the Sm—Fe—N-based anisotropic magnetic powder may be filtered, dehydrated, and dried by normal methods.

### Other Components

The curable composition for a bonded magnet of the present embodiment may further comprise, as necessary, various additives such as a filler (preferably an inorganic filler), a lubricant, a dispersant, an antioxidant, a heavy metal deactivator, a crystal nucleating agent, a flame retardant, a plasticizer, an ultraviolet absorber, an antistatic agent, a colorant, and a mold release agent, and optional components such as a thermoplastic resin, a thermoplastic elastomer, and a thermosetting resin other than an epoxy resin.

Examples of the lubricant and the dispersant include waxes such as paraffin wax, polyethylene wax, and polypropylene wax, fatty acids such as stearic acid and salts thereof, metal soaps, fatty acid amides, urea compounds, fatty acid esters, polyethers, polysiloxanes such as silicone oil and silicone grease, fluorine-based oils, fluorine-based greases, and fluororesin powders. A single type of the lubricant and dispersant may be used, or a combination of two or more thereof may be used.

The resin added to the curable composition for a bonded magnet is not particularly limited, and examples thereof include thermosetting resins such as phenolic resins, unsaturated polyester resins, vinyl esters (epoxy acrylates), diallyl phthalate resins, urea resins, melamine resins, and urethane resins, and thermoplastic resins such as polyphenylene sulfide, polyamides, polyesters, polycarbonates, polystyrene, ABS, polyethylenes, polypropylenes, polyether ether ketones, liquid crystal polymers, polyethylene terephthalate, polybutylene terephthalate, polyphenylene ether, cycloolefin polymers, and cycloolefin copolymers. A single type of these thermosetting resins and thermoplastic resins may be used, or two or more may be used in combination.

### Method for Producing Curable Composition for Bonded Magnet

The curable composition for a bonded magnet according to the present embodiment may be obtained by, for example, mixing and kneading a magnetic powder, at least one (epoxy resin(s) as main agent(s)) of phenol novolac-type epoxy resins, cresol novolac-type epoxy resins, and triphenylmethane-type epoxy resins, each preferably having an epoxy equivalent that is 250 g/eq or less, at least one (phenolic resin-based curing agent(s)) of novolac-type phenolic resins, cresol novolac-type phenolic resins, or triphenylmethane-type phenolic resins, each preferably having a hydroxyl equivalent that is 150 g/eq or less, a phosphate ester, and other components (epoxy resin(s) and curing agent(s) other than the above, additive(s) such as a curing accelerator or a filler, resin(s) other than epoxy resin(s), and the like) that are added as necessary.

The mixing and kneading method and conditions are not particularly limited, and may be appropriately selected with reference to known methods. For example, a mixture comprising a magnetic powder, an epoxy resin as described above, a phenolic resin-based curing agent as described above, and a phosphate ester, and comprising other optional components as necessary is kneaded using a kneader such as a single-screw kneader or a twin-screw kneader. The kneading temperature may be any temperature at which progression of the curing reaction is suppressed, and be, for example, 140° C. or less, preferably in a range of 60° C. to 110° C., and more preferably in a range of 60° C. to 85° C. The kneading time is not particularly limited and may be appropriately determined, and for example, may be in a range of 1 minute to 10 minutes.

For example, after the magnetic powder, the epoxy resin as described above, the phenolic resin-based curing agent as described above, the phosphate ester, and other optional components added as necessary have been mixed and kneaded, a strand is extruded by a twin-screw extruder, air cooled, and then cut to a desired size (for example, several mm) by a pelletizer, and thereby a pellet-shaped curable composition for a bonded magnet may be obtained. The pellet-shaped curable composition for a bonded magnet may be suitably used in injection molding.

In addition, for example, a tablet-shaped curable composition for a bonded magnet may be obtained by mixing and kneading a magnetic powder, the epoxy resin as described above, the phenolic resin-based curing agent as described above, a phosphate ester, and other optional components as necessary, and then grinding the mixture using a ball mill, a high speed mill, or the like, and compression-molding (tableting) the obtained ground product. Compression molding may be performed, for example, by filling a mold with the ground product, and then pressurizing at a pressure in an approximate range of, for example, from 2 to 20 MPa. The tablet-shaped curable composition for a bonded magnet may be suitably used in transfer molding.

### Method for Producing Bonded Magnet

A method for producing a bonded magnet according to an embodiment of the present disclosure comprises a step (hereinafter, also referred to as a “curing and molding step”) of injection molding or transfer molding a curable composition for a bonded magnet as described above, and then curing the molded composition. By employing injection molding or transfer molding, bonded magnets having various shapes ranging from a simple shape to a relatively complex shape may be easily produced. Therefore, a bonded magnet having a high degree of freedom in shape and good properties such as heat resistance and oil resistance may be successfully produced.

A bonded magnet may be produced by a molding method other than injection molding and transfer molding, such as, for example, compression molding, extrusion molding, or potting, from the curable composition for a bonded magnet described above, that is, from the bonded magnet curable composition comprising a magnetic powder, at least one epoxy resin selected from phenol novolac-type epoxy resins, cresol novolac-type epoxy resins, and triphenylmethane-type epoxy resins, each preferably having an epoxy equivalent that is 250 g/eq or less, at least one phenolic resin-based curing agent selected from novolac-type phenolic resins, cresol novolac-type phenolic resins, and triphenylmethane-type phenolic resins, each preferably having a hydroxyl equivalent that is 150 g/eq or less, and a phosphate ester. The curable composition for a bonded magnet may also be configured to not comprise a phosphate ester depending on the molding method or by appropriately controlling the molding conditions.

As described above, in the method for producing a bonded magnet according to the present embodiment, the curable composition for a bonded magnet may be injection molded or transfer-molded and then cured. More specifically, the curable composition for a bonded magnet may be softened by heating, and then injected or poured into a cavity (hollow portion) of a heated mold and cured.

The temperature at which the curable composition for a bonded magnet is softened is not particularly limited and may be appropriately selected according to the types of the magnetic powder, epoxy resin, and curing agent to be used, and the like, but is usually preferably 140° C. or lower, and more preferably 130° C. or lower. In one aspect of the present embodiment, the temperature at which the curable composition for a bonded magnet is softened is more preferably 120° C. or lower and may be further preferably 100° C. or lower in some cases. In one aspect of the present embodiment, the temperature at which the curable composition for a bonded magnet is softened may be an even higher temperature, and for example, may be 190° C. or lower, and more preferably 180° C. or lower. The lower limit of the temperature at which the curable composition for a bonded magnet is softened is not particularly limited, but is usually preferably 60° C. or higher. The heating time (softening time) for softening the curable composition for a bonded magnet is not particularly limited and may be appropriately determined. For example, the heating time may be set to a range of 10 seconds to 3600 seconds, but the heating time is preferably a relatively short time from the viewpoint of productivity.

The temperature at which the curable composition for a bonded magnet is cured (that is, the temperature of the mold into which the curable composition for a bonded magnet is injected or poured) is not particularly limited and may be appropriately selected according to the types of the magnetic powder, epoxy resin, and curing agent to be used, and the like. However, from the viewpoint of productivity and the heat resistance of the obtained bonded magnet, the curing temperature thereof is usually preferably higher than 150° C. and more preferably 160° C. or higher. In one aspect of the present embodiment, the temperature for curing the curable composition for a bonded magnet is more preferably 170° C. or higher, and may be more preferably 175° C. or higher in some cases, particularly from the viewpoint of the heat resistance of the bonded magnet to be obtained. The upper limit of the temperature at which the curable composition for a bonded magnet is cured is not particularly limited, but is usually preferably 250° C. or lower from the viewpoint of suppressing decomposition of the material. The time (curing time) for which the curable composition for a bonded magnet is held in the cavity of the heated mold for curing may be appropriately selected from the viewpoints of productivity and the degree of progression of the curing reaction, and is preferably in a range of 20 seconds to 180 seconds, for example.

In the case of the transfer molding method, the temperature at which the curable composition for a bonded magnet is softened is usually the same as the temperature at which the curable composition for a bonded magnet is cured. In this case as well, the temperature for softening and curing the curable composition for a bonded magnet, the softening time, and the curing time may be appropriately selected according to the types of the magnetic powder, epoxy resin, and curing agent to be used, and the like, and thereby the bonded magnet may be successfully molded.

In the method for producing a bonded magnet according to one aspect of the present embodiment, the bonded magnet may be molded and produced by an injection molding method. For example, an injection molding machine may be used to heat, soften, and melt the curable composition for a bonded magnet in a screw cylinder, after which the composition is injected into a cavity of a mold to which a magnetic field is applied, and the magnetic powder is cured with the easily magnetized axes of the magnetic powder being aligned (oriented). The orienting magnetic field at that time may be generated using an electromagnet or a permanent magnet. The magnitude of the orienting magnetic field is not particularly limited, but is usually preferably 4 kOe or greater, and more preferably 6 kOe or greater. Subsequently, the cured product is removed from the mold, and if necessary, magnetized with an air-core coil or a magnetizing yoke, and thereby a bonded magnet may be obtained. The magnitude of the magnetizing magnetic field is also not particularly limited, but is usually preferably 20 kOe or greater, and more preferably 30 kOe or greater.

In the method for producing a bonded magnet according to one aspect of the present embodiment, the bonded magnet may be molded and produced using a transfer molding method. For example, a transfer molding machine may be used to heat and soften the curable composition for a bonded magnet in a pot of a mold, after which the composition is poured into the cavity of the mold to which a magnetic field is applied, and the magnetic powder is cured with the easily magnetized axes of the magnetic powder being aligned (oriented). The orienting magnetic field at that time may be generated using an electromagnet or a permanent magnet. The magnitude of the orienting magnetic field is not particularly limited, but is usually preferably 4 kOe or greater, and more preferably 6 kOe or greater. Subsequently, the cured product is removed from the mold, and if necessary, magnetized with an air-core coil or a magnetizing yoke, and thereby a bonded magnet may be obtained. The magnitude of the magnetizing magnetic field is also not particularly limited, but is usually preferably 20 kOe or greater, and more preferably 30 kOe or greater. The injection pressure when the softened curable composition for a bonded magnet is poured into the cavity of the mold is not particularly limited, but is usually preferably in a range of 5 MPa to 30 MPa, and more preferably in a range of 5 MPa to 15 MPa.

As described above, the molding method when producing a bonded magnet using the curable composition for a bonded magnet according to the present embodiment is not limited to injection molding and transfer molding, and any known method such as compression molding, extrusion molding, and potting may be adopted, although the degree of freedom in shape may be reduced. The molding conditions in this case are not particularly limited, and may be appropriately set with reference to the known method. Moreover, the temperature of the molding machine and the magnitudes of the orienting magnetic field and the magnetizing magnetic field may be set in the same manner as described above, for example.

The bonded magnet obtained from the curable composition for a bonded magnet according to the present embodiment has good magnetic properties inherent to the magnetic powder, and further, since the binder resin is an epoxy resin, the bonded magnet is good in heat resistance, mechanical strength, and the like, and is particularly good in oil resistance, even among various epoxy resins. Therefore, the bonded magnet may be particularly suitably used in applications in which the bonded magnet is immersed in or in contact with oil, such as for example, in an on-vehicle main motor, an oil pump, a valve actuator, and the like. In addition, the bonded magnet may be suitably used in various applications in which the bonded magnet is not immersed in or in contact with oil. For example, the bonded magnet may be used in applications in which heat resistance and thermal deformation resistance are required, such as in an on-vehicle auxiliary motor, an electric water pump, and an electric power steering motor. The bonded magnet of the present embodiment may be suitably used in applications in which the bonded magnet may be immersed in or in contact with oil, such as in an air conditioner compressor or other such home appliance applications, and in aviation applications such as a drive motor for aerodynamic mobility such as a drone.

### Bonded Magnet

A bonded magnet according to one aspect of the present embodiment comprises a cured product of a curable composition comprising: a magnetic powder; at least one epoxy resin that is at least one of a phenol novolac-type epoxy resin, a cresol novolac-type epoxy resin, or a triphenylmethane-type epoxy resin; and at least one phenolic resin-based curing agent that is at least one of a novolac-type phenolic resin, a cresol novolac-type phenolic resin, or a triphenylmethane-type phenolic resin, and the bonded magnet is used in applications in which the bonded magnet is immersed in or in contact with an oil. The phenol novolac-type epoxy resin, the cresol novolac-type epoxy resin, or the triphenylmethane-type epoxy resin preferably has an epoxy equivalent that is 250 g/eq or less. The novolac-type phenolic resin, the cresol novolac-type phenolic resin, or the triphenylmethane-type phenolic resin preferably has a hydroxyl equivalent that is 150 g/eq or less.

The curable composition may further comprise a phosphate ester, and therefore, the cured product of the curable composition in the bonded magnet of the present aspect may be a cured product of the curable composition for a bonded magnet as described above. The curable composition may comprise an epoxy resin other than the phenol novolac-type epoxy resin, cresol novolac-type epoxy resin, and triphenylmethane-type epoxy resin, and may comprise a phenolic resin-based curing agent other than the novolac-type phenolic resin, cresol novolac-type phenolic resin, and triphenylmethane-type phenolic resin, and another curing agent.

Examples of the components comprised in the bonded magnet of the present embodiment including the magnetic powder, the at least one (main agent(s)) selected from phenol novolac-type epoxy resins, cresol novolac-type epoxy resins, and triphenylmethane-type epoxy resins, each preferably having an epoxy equivalent that is 250 g/eq or less, and the at least one (phenolic resin-based curing agent(s)) selected from novolac-type phenolic resins, cresol novolac-type phenolic resins, and triphenylmethane-type phenolic resins, each preferably having a hydroxyl equivalent that is 150 g/eq or less, are the same as those comprised in the curable composition for a bonded magnet described above, and preferred examples thereof are also the same. Examples of the phosphate ester are also the same as those comprised in the above-described curable composition for a bonded magnet, and preferred examples thereof are also the same.

The preferred range of the content of each component in the bonded magnet is also the same as the preferred range of the content of each component in the above-described curable composition for a bonded magnet. The content of the magnetic powder in the bonded magnet is preferably less than 95 mass %, and more preferably 93 mass % or less. Moreover, the content of the magnetic powder in the bonded magnet is preferably 80 mass % or greater, and is more preferably 85 mass % or greater.

Similar to the curable composition for a bonded magnet described above, the bonded magnet of the present embodiment may also further comprise, as necessary, other resins and other components such as a curing agent, a curing accelerator, and an additive.

The bonded magnet of the present embodiment may be produced by curing the curable composition as described above. The curing method and the curing conditions are not particularly limited, and may be appropriately selected according to the types of the epoxy resin, curing agent, and curing accelerator to be used, and the like.

The bonded magnet of the present embodiment may be produced, for example, by the above-described method for producing a bonded magnet. The bonded magnet according to one aspect of the present embodiment may be obtained from a curable composition not comprising a phosphate ester, but in this case as well, the moldability is poor, and therefore the molding conditions are difficult to control. However, by adopting the transfer molding method for example, a bonded magnet may be produced from the curable composition in the same manner as in the above-described method for producing a bonded magnet.

The bonded magnet of the present embodiment may be molded and produced by injection molding or transfer molding, and may be formed with a relatively complex shape. The shape of the bonded magnet is not particularly limited, and may be a relatively simple shape. The molding method is also not limited to injection molding and transfer molding.

The bonded magnet of the present embodiment is used in applications in which the bonded magnet is immersed in or in contact with oil. The bonded magnet of the present embodiment uses, as a binder resin, a reaction product of an epoxy resin main agent comprising at least one of a phenol novolac-type epoxy resin, a cresol novolac-type epoxy resin, or a triphenylmethane-type epoxy resin, and a curing agent comprising at least one of a novolac-type phenolic resin, a cresol novolac-type phenolic resin, or a triphenylmethane-type phenolic resin, and the bonded magnet exhibits good properties such as heat resistance and also good oil resistance.

More specifically, the bonded magnet of the present embodiment may be particularly suitably used in an on-vehicle main motor, an oil pump, a valve actuator, and the like.

An on-vehicle main motor according to one aspect of the present embodiment comprises the bonded magnet as described above. An oil pump according to one aspect of the present embodiment comprises the bonded magnet as described above. The on-vehicle main motor and the oil pump obtained using the above-described bonded magnet having good heat resistance and oil resistance exhibit good performance and are highly practical.

### EXAMPLES

### Production Example (Preparation of Rare Earth Magnetic Powder)

### Precipitation Step

5.0 kg of FeSO₄·7H₂O was mixed and dissolved in 2.0 kg of pure water. In addition, 0.49 kg of Sm₂O₃ and 0.74 kg of 70% sulfuric acid were added and the mixture was stirred well to completely dissolve the material. Subsequently, pure water was added to the resulting solution to adjust the solution such that the final Fe concentration was 0.726 mol/L and the final Sm concentration was 0.112 mol/L, and thereby a SmFe sulfuric acid solution was prepared.

Into 20 kg of pure water maintained at a temperature of 40° C., the entire amount of the prepared SmFe sulfuric acid solution was added dropwise while being stirred over a period of 70 minutes from the startup of the reaction, and at the same time, a 15% ammonia solution was added dropwise to adjust the pH to a range of 7 to 8. As a result, a slurry comprising SmFe hydroxide was formed. The precipitate (SmFe hydroxide) was separated from the obtained slurry through decantation and then washed with pure water, after which the hydroxide was solid-liquid separated. The separated hydroxide was dried in an oven at 100° C. for 10 hours.

### Oxidation Step

The hydroxide formed in the precipitation step was calcined at 1000° C. in air for 1 hour. The fired hydroxide was cooled, after which a red SmFe oxide was formed as a raw material powder.

### Pretreatment Step

100 g of the SmFe oxide obtained in the oxidation step was placed into a steel container such that the bulk thickness was 10 mm. The container was placed into a furnace, and the pressure was reduced to 100 Pa, after which the temperature in the furnace was increased to 850° C. while hydrogen gas was being introduced, and this state was maintained for 15 hours. Through this, a partial oxide in which a portion of the oxide was reduced was obtained.

### Reduction Step

60 g of the partial oxide formed in the pretreatment step and 19.2 g of metal calcium having an average particle size of approximately 6 mm were mixed and placed into a furnace. The inside of the furnace was evacuated to create a vacuum state, after which argon gas (Ar gas) was introduced into the furnace. Subsequently, the temperature in the furnace was increased to 1045° C. and maintained for 45 minutes, and thereby Sm—Fe alloy particles were obtained.

### Nitriding Step

Subsequently, the temperature inside the furnace was cooled to 100° C., after which the furnace was evacuated to a vacuum state, the temperature was increased to 450° C. while nitrogen gas was being introduced, and that state was maintained for 23 hours, and as a result, a clump-shaped product comprising Sm—Fe—N-based magnetic particles was obtained.

### Rinsing Step

The product in a bulk form formed in the nitriding step was put into 3 kg of pure water and the mixture was stirred for 30 minutes. The formed solution was left standing, after which the supernatant was drained by decantation. The process of putting into pure water, stirring, and decantation was repeated 10 times. Subsequently, 3 kg of pure water and 2.5 g of 99.9% acetic acid were sequentially poured into the decanted slurry, and the mixture was stirred for 15 minutes. The formed solution was left standing, after which the supernatant was drained by decantation. The process of putting into 3 kg of pure water, stirring and decantation was repeated twice, after which the formed product was dehydrated and dried, and then subjected to mechanical crushing, and thereby a Sm—Fe—N-based magnetic powder (average particle size (D50) of 3 μm) was formed.

### Phosphoric Acid Treatment Step

A phosphoric acid treatment solution was prepared by mixing 85% ortho-phosphoric acid, sodium dihydrogen phosphate, and sodium molybdate dihydrate at a mass ratio of 1:6:1 (85% ortho-phosphoric acid:sodium dihydrogen phosphate:sodium molybdate dihydrate), and then adjusting the pH to 2.5 and the PO₄ concentration to 20 mass % using pure water and dilute hydrochloric acid. Subsequently, 1000 g of the Sm—Fe—N-based magnetic powder obtained in the rinsing step was stirred for 1 minute in 10 L of dilute hydrochloric acid comprising 0.7 mass % of hydrogen chloride to remove the surface oxide film and contaminants, after which drainage and water injection were repeated until the conductivity of the supernatant became 100 S/cm, and a slurry comprising 10 mass % of the Sm—Fe—N-based magnetic powder was obtained. While the formed slurry was stirred, a total amount of 100 g of the prepared phosphoric acid treatment solution was poured into the treatment tank, after which the pH of the phosphoric acid treatment reaction slurry was controlled to a range of 2.5±0.1 by adding 6 mass % of hydrochloric acid as needed, and this state was maintained for 30 minutes. Subsequently, the mixture was suction-filtered, dehydrated, and vacuum-dried, and thereby a phosphate-coated Sm—Fe—N-based magnetic powder (residual magnetic flux density Br: 13.0 kG, coercivity iHc: 19.8 kOe, average particle size: 3.32 μm, D10: 1.59 μm, D50: 3.24 μm, D90: 5.15 μm, particle size distribution: 1.10) was obtained.

Oxidation Step after Phosphoric Acid Treatment Step

An amount of 1000 g of the obtained phosphate-coated Sm—Fe—N-based magnetic powder was gradually heated from room temperature in a mixed gas (oxygen concentration of 4%, flow rate of 5 L/min) atmosphere of nitrogen and air, and heat treated at a maximum temperature of 230° C. for 8 hours, and an oxidized phosphate-coated Sm—Fe—N-based magnetic powder was obtained.

Examples 1 to 3 and Comparative Examples 1 and 2 According to the formulations described in Table 1, the magnetic powder, the epoxy resin, the curing agent, the dispersant, and the curing accelerator were weighed and kneaded. Subsequently, the mixture was kneaded with a Labo Plastomill (10 rpm, test volume 40 cc, residence time: 6 minutes), and a curable composition for a bonded magnet was thereby obtained. The kneading temperature was set to 85° C. in Examples 1 to 3 and to 110° C. in Comparative Examples 1 and 2 in accordance with the softening point of the resin.

The components used in the examples and comparative examples were as follows.

### Magnetic Powder

SmFeN-based magnetic powder produced in the Production Example

### Epoxy Resin Main Agent

Main agent 1: EPPN-501H (triphenylmethane-based polyfunctional epoxy resin (thermosetting oligomer) available from Nippon Kayaku Co., Ltd., number of epoxy groups in the repeating structural unit: 2, epoxy equivalent: 166 g/eq, softening point: 53° C.)
Main agent 2: NC-3500 (biphenyl-based polyfunctional epoxy resin (thermosetting oligomer) available from Nippon Kayaku Co., Ltd., number of epoxy groups in repeating structural unit: 1 or 2, epoxy equivalent: 210 g/eq, softening point: 73° C.)
Main agent 3: YX4000K (biphenyl-based crystalline epoxy resin available from Mitsubishi Chemical Corporation, melting point: 105° C., number of epoxy groups per molecule: 2, epoxy equivalent: 186 g/eq)

### Curing Agent

Curing agent 1: PHENOLITE TD-2131 (novolac-type phenolic resin available from DIC Corporation, hydroxyl equivalent: 104 g/eq, softening point: 80° C.)
Curing agent 2: MEH-7500 (triphenylmethane-based phenolic resin (curing agent oligomer) available from UBE Industries, Ltd., hydroxyl equivalent: 98 g/eq, softening point: 111° C.)
Curing agent 3: dicyandiamide (DICY) (available from Tokyo Chemical Industry Co., Ltd., melting point: 209.5° C., functional group equivalent: 21 g/eq)

### Dispersant

Dispersant 1: Phosphanol RS-410 (polyoxyethylene tridecyl ether phosphate available from Toho Chemical Industry Co., Ltd.)
Dispersant 2: BYK-W9010 (polyester phosphate available from BYK-Chemie GmbH)

### Curing Accelerator

Curing accelerator 1: Ucat 3512T (aromatic dimethylurea-based curing accelerator available from San-Apro Ltd.)
Curing accelerator 2: Curezol 2PHZ-PW (imidazole-based curing accelerator available from Shikoku Chemicals Corporation)

TABLE 1

| | | | | | | | | | | Curing Accelerator | |
|---|---|---|---|---|---|---|---|---|---|---|---|
| | | Epoxy Resin Main Agent | | | Curing Agent | | | Dispersant | | Curing | Curing |
| | Magnetic | Main | Main | Main | Curing | Curing | Curing | Dispersant | Dispersant | Accelerator | Accelerator |
| | Powder | Agent 1 | Agent 2 | Agent 3 | Agent 1 | Agent 2 | Agent 3 | 1 | 2 | 1 | 2 |
| Example | [parts by | [parts by | [parts by | [parts by | [parts by | [parts by | [parts by | [parts by | [parts by | [parts by | [parts by |
| Number | mass] | mass] | mass] | mass] | mass] | mass] | mass] | mass] | mass] | mass] | mass] |
| Example 1 | 100 | 5.2 | — | — | 3.3 | — | — | 0.20 | — | 0.22 | — |
| Example 2 | 100 | 5.3 | — | — | 3.3 | — | — | 0.10 | — | 0.22 | — |
| Example 3 | 100 | 5.1 | — | — | 3.3 | — | — | 0.30 | — | 0.22 | — |
| Comparative | 100 | — | 3.2 | 5.3 | — | 1.0 | 0.7 | — | 0.20 | 0.15 | — |
| Example 1 | | | | | | | | | | | |
| Comparative | 100 | — | — | 7.1 | — | 3.8 | — | — | — | — | 0.27 |
| Example 2 | | | | | | | | | | | |

The following evaluations were conducted using the curable compositions for bonded magnets obtained in Examples 1 to 3 and Comparative Examples 1 and 2. Table 2 shows the evaluation results.

### 90° C. Stable Retention Time (A)

The torque was monitored when the obtained curable composition for a bonded magnet was kneaded at 90° C., a rotational speed of 10 rpm, and a test volume of 40 cc using the Labo Plastomill, and the time until the torque increased to 1.3 times the initial value was measured and defined as the 90° C. stable retention time (A). The time (A) was measured up to 3600 seconds at maximum, and the measurement was terminated at that point. Therefore, the upper limit value of the time (A) was 3600 seconds. As the time (A) increases, the increase in viscosity due to curing of the material in the cylinder at the time of injection molding can be more suppressed, and a high level of fluidity can be maintained for a longer period of time.

### 180° C. Curing Time (B)

While 2.0 g of the obtained curable composition for a bonded magnet was kneaded on a hot plate heated to 180° C., the time required for fully curing the composition was measured, and the time thereof was defined as the 180° C. curing time (B). As the time (B) becomes shorter, the material is cured more rapidly in the mold, and therefore, the mold closing time and the cycle time can be shortened. From the viewpoint of productivity, the time (B) is desirably 90 seconds or less.

### Cycle Stability (A/B) of Injection Molding

The cycle stability (A/B) of injection molding was calculated by dividing the 90° C. stable retention time (A) by the 180° C. curing time (B). It is clear that a larger value of (A/B) is more advantageous for continuous cycle molding. The above results are shown in Table 2.

TABLE 2

| | 90° C. Stable | 180° C. | Cycle Stability |
|---|---|---|---|
| | Retention | Curing | of Injection |
| | Time | Time | Molding |
| | (A) | (B) | (A/B) |
| Example Number | [sec] | [sec] | [—] |
| Example 1 | 3426 | 32 | 107 |
| Example 2 | 2730 | 28 | 98 |
| Example 3 | 3558 | 41 | 87 |
| Comparative Example 1 | 3006 | 55 | 55 |
| Comparative Example 2 | 2118 | 100 | 21 |

Each of the curable compositions for a bonded magnet in Examples 1 to 3 exhibited relatively high 90° C. retention stability and a relatively short 180° C. curing time and had good cycle stability. On the other hand, in Comparative Examples 1 and 2, the curable compositions for a bonded magnet exhibited a relatively rapid increase in viscosity, the 90° C. retention stability was low, and the 180° C. curing time was relatively long, and thus the compositions thereof were not suited for injection molding.

### Flexural Strength

The curable compositions for a bonded magnet of Example 1 and Comparative Examples 1 and 2 were each charged into a hopper of an injection molding machine available from The Japan Steel Works, Ltd., with the injection molding machine having a cylinder temperature set to 50° C. in zone 1 and 85° C. in zone 2, and the mold temperature set to 200° C. The material was measured up to a predetermined measuring position at a screw rotational speed of 20 rpm, the material was injected into the mold under conditions including an injection speed 10 mm/s, an injection pressure of 30 MPa, and an orienting magnetic field of 9 kOe, and the mold was opened after 90 seconds, and thereby a long test piece having a length 100 mm, a width of 12 mm, and a height of 4 mm was produced. The obtained long test piece was annealed in an oven at 200° C. for 1 hour, and then subjected to a three-point bending test (distance between supporting points: 50 mm, speed: 2 mm/min) using a multipurpose strength tester to measure the flexural strength. The results of the above are shown in Table 3.

### Decomposition Resistance

An evaluation test piece having a width of 7 mm, a length of 7 mm, and a height of 4 mm was cut out by milling from a long test piece having a length 100 mm, a width of 12 mm, and a height of 4 mm, the long test piece thereof being obtained in the same manner as the long test piece produced for evaluating the flexural strength. The obtained evaluation test piece was subjected to the below-described durability test, and then embedded in an epoxy resin for encapsulation, cross-sectioned, and polished with an alumina abrasive in this order, and the surface of a sample of the obtained material was observed by SEM-EDS to thereby evaluate the decomposition resistance. Two types of durability test conditions were used, namely a durability test at 180° C. atmospheric exposure for 500 hours and a durability test involving immersion in a commercially available automatic transmission fluid (ATF) at 150° C. for 1000 hours. Samples in which discoloration, a decrease in the carbon (C) concentration, and/or an increase in the oxygen (O) concentration was observed on the surface of the sample were evaluated as “decomposed”. The results of the above are shown in Table 3.

### Magnetic Property (BH) Max

A long test piece having a length of 100 mm, a width of 12 mm, and a height of 4 mm was prepared in the same manner as the long test piece for the flexural strength evaluation. A rectangular parallelepiped magnet having a width of 7 mm, a length of 7 mm, and a height of 4 mm was cut out from the obtained long test piece by milling, and the obtained rectangular parallelepiped was pulse-magnetized at 60 kOe, after which the magnetic property (BH) max at room temperature was measured using a BH curve tracer available from Riken Denshi Co., Ltd. The results of the above are shown in Table 3.

### Glass Transition Temperature (Tg)

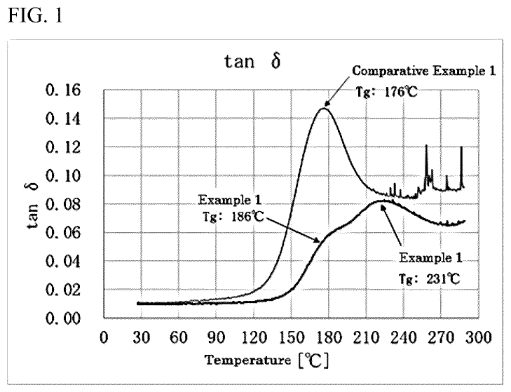

The obtained flexural strength test pieces of Example 1 and Comparative Example 1 were subjected to dynamic mechanical analysis (DMA) measurements in a three-point bending measurement mode in a temperature range from room temperature to 300° C., and the storage elastic modulus (E′, G′), the loss elastic modulus (E″, G″), and the loss tangent (tan δ=E″/E′) were measured. The glass transition temperature (Tg) was evaluated by reading the peak position of the graph of the loss tangent. A graph of the loss tangent is shown in FIG. 1.

TABLE 3

| | | Presence or Absence | | | |
|---|---|---|---|---|---|
| | | of Decomposition | | | |
| | Flexural | 180° C. | 180° C. | | |
| Example | Strength | atmosphere | ATF | (BH)max | |
| Number | [MPa] | [—] | [—] | [MGOe] | [kJ/m³] |
| Example 1 | 85 | Absent | Absent | 17.1 | 137 |
| Comparative | 74 | Present | Present | 15.0 | 120 |
| Example 1 | | | | | |
| Comparative | 66 | Present | Present | 13.9 | 111 |
| Example 2 | | | | | |

The curable composition for a bonded magnet of Example 1 exhibited high retention stability, and the bonded magnet (cured product) that was obtained had good flexural strength, magnetic properties, and decomposition resistance. On the other hand, in Comparative Examples 1 and 2, the flexural strength, decomposition resistance, and magnetic properties of the obtained bonded magnets (cured products) were poor. In addition, from FIG. 1, the cured product of the curable composition of Comparative Example 1 exhibited a Tg at about 176° C., whereas the cured product of the curable composition of Example 1 exhibited two Tg's at about 186° C. and about 231° C., and thus it can be confirmed that the cured product of the example, that is, the bonded magnet, exhibited high heat resistance.

What is claimed is:

1. A bonded magnet for use in an application in which the bonded magnet is immersed in or in contact with oil, the bonded magnet comprising:
a cured product of a curable composition comprising:
a magnetic powder;
at least one epoxy resin that is at least one of a phenol novolac-type epoxy resin, a cresol novolac-type epoxy resin, or a triphenylmethane-type epoxy resin; and
at least one phenolic resin-based curing agent that is at least one of a novolac-type phenolic resin, a cresol novolac-type phenolic resin, or a triphenylmethane-type phenolic resin.

2. The bonded magnet according to claim 1, wherein
the at least one epoxy resin has an epoxy equivalent that is 250 g/eq or less, and
the at least one phenolic resin-based curing agent has a hydroxyl equivalent that is 150 g/eq or less.

3. The bonded magnet according to claim 1, wherein the curable composition further comprises a phosphate ester.

4. The bonded magnet according to claim 3, wherein the phosphate ester is a polyoxyethylene alkyl ether phosphate.

5. The bonded magnet according to claim 1, wherein a content of the magnetic powder in the bonded magnet is 80 mass % or more and less than 95 mass %.

6. The bonded magnet according to claim 1, wherein the magnetic powder is a Sm—Fe—N-based magnetic powder.

7. The bonded magnet according to claim 1, wherein the bonded magnet is to be used in an on-vehicle main motor or an oil pump.

8. An on-vehicle main motor comprising the bonded magnet according to claim 1.

9. An oil pump comprising the bonded magnet according to claim 1.

10. A curable composition for a bonded magnet, the curable composition comprising:
a magnetic powder;
at least one epoxy resin that is at least one of a phenol novolac-type epoxy resin, a cresol novolac-type epoxy resin, or a triphenylmethane-type epoxy resin;
at least one phenolic resin-based curing agent that is at least one of a novolac-type phenolic resin, a cresol novolac-type phenolic resin, or a triphenylmethane-type phenolic resin; and
a phosphate ester.

11. The curable composition according to claim 10, wherein the at least one epoxy resin has an epoxy equivalent that is 250 g/eq or less, and the at least one phenolic resin-based curing agent has a hydroxyl equivalent that is 150 g/eq or less.

12. The curable composition according to claim 10, wherein the phosphate ester is a polyoxyethylene alkyl ether phosphate.

13. The curable composition according to claim 10, wherein a content of the magnetic powder in the curable composition is 80 mass % or more and less than 95 mass %.

14. The curable composition according to claim 10, wherein the magnetic powder is a Sm—Fe—N-based magnetic powder.

15. A method for producing a bonded magnet, the method comprising injection molding or transfer molding the curable composition according to claim 10, and curing the molded composition.
